(19) United States
(12) Patent Application Publication
(10) Pub. No.: US 2023/0222944 A1
(43) Pub. Date: Jul. 13, 2023

(54) SIMULATION DEVICES, SYSTEMS, AND ASSOCIATED METHODS FOR USE WITH AUTOMATED BLOOD PRESSURE MONITORING

(71) Applicant: GAUMARD SCIENTIFIC COMPANY, INC., Miami, FL (US)

(72) Inventors: Miguel Carvajal, Miami Springs, FL (US); Alberto Rodriguez, Miami, FL (US)

(21) Appl. No.: 18/153,752

(22) Filed: Jan. 12, 2023

Related U.S. Application Data
(60) Provisional application No. 63/266,761, filed on Jan. 13, 2022.

(51) Int. Cl. G09B 23/30

(52) U.S. Cl. CPC G09B 23/303

(57) ABSTRACT

The present disclosure provides interactive education systems, apparatus, components, and methods for teaching patient care. In some aspects of the present disclosure, a system comprises: a patient simulator having a simulated body portion; an air pressure sensor positioned within the simulated body portion; a first air chamber positioned within the patient simulator, the first air chamber in communication with the air pressure sensor; a mechanism for selectively contacting the first air chamber; and an adapter positioned outside the patient simulator, the adapter in communication with the air pressure sensor and configured to be in communication with an air line of an automated pressure monitoring apparatus.

### CROSS-REFERENCE TO RELATED APPLICATIONS

The present application claims priority to and the benefit of U.S. Provisional Application No. 63/266,761, filed Jan. 13, 2022, which is hereby incorporated by reference in its entirety.

### INTRODUCTION

The present disclosure relates generally to interactive education systems for teaching patient care. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. patent application Ser. No. 11/952,559 (Publication No. 20080138778), U.S. patent application Ser. No. 11/952,606 (Publication No. 20080131855), U.S. patent application Ser. No. 11/952,636 (Publication No. 20080138779), U.S. patent application Ser. No. 11/952,669 (Publication No. 20090148822), U.S. patent application Ser. No. 11/952,698 (Publication No. 20080138780), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure provides interactive education systems, apparatus, components, and methods for teaching patient care. In some aspects of the present disclosure, a system for teaching patient care is provided. The system may include a patient simulator with a patient body comprised of one or more simulated body portions. The one or more simulated body portions includes at least one simulated arm portion. The at least one simulated arm portion is configured to provide brachial artery simulation for non-invasive blood pressure monitoring. In some instances, the at least one simulated arm portion is configured to interface with an automated blood monitoring apparatus to simulate a blood pressure of the patient simulator. In some instances, the at least one simulated arm portion includes a sensor for monitoring an air pressure generated by the automated blood pressure monitoring apparatus and a mechanism for causing a simulated pulse in an air line of the automated blood pressure monitoring apparatus. In this regard, the patient simulator may be configured to generate simulated pulses in the air line of the automated blood pressure monitoring apparatus based on a desired blood pressure of the patient simulator. For example, the patient simulator may monitor the air pressure generated by the automated blood pressure monitoring apparatus and generate oscillations in the pressure of the air line to simulate pulses (e.g., brachial and/or radial pulses) in accordance with the desired simulated blood pressure.

Generally speaking, an automated blood pressure monitoring apparatus often generates an initial air pressure at a value corresponding to a blood pressure significantly higher than expected for a patient and then slowly decreases the initial air pressure while monitoring the pressure in the air line, including oscillations caused by the pulse of the patient, in order to determine the patient's blood pressure. More specifically, the automated blood pressure monitoring apparatus can utilize the air pressure in the air line and the strength of the oscillations caused by the pulses to determine the systolic and diastolic blood pressures for the patient.

In accordance with aspects of the present disclosure, the strength of the oscillations induced in the air line of the automated blood pressure monitoring apparatus caused by the mechanism for causing the simulated pulses can be modified as the air pressure generated by the automated blood pressure monitoring apparatus decreases (e.g., as monitored by the sensor) in order to simulate pulse patterns consistent with the desired systolic and diastolic blood pressures. In some instances, the patient simulator is further configured to produce one or more sounds based on the simulated blood pressure. For example, the one or more sounds may include Korotkoff sounds, brachial pulse, radial pulse, and other related blood pressure related sounds. In that regard, the patient simulator may include one or more speakers for producing the one or more sounds in some instances. The one or more sounds based on the simulated blood pressure may be coordinated with the simulated pulses in the air line of the automated blood pressure monitoring apparatus in accordance with the desired blood pressure of the patient simulator.

In some aspects of the present disclosure, a system comprises: a patient simulator having a simulated body portion; an air pressure sensor positioned within the simulated body portion; a first air chamber positioned within the patient simulator, the first air chamber in communication with the air pressure sensor; a mechanism for selectively contacting the first air chamber; and an adapter positioned outside the patient simulator, the adapter in communication with the air pressure sensor and configured to be in communication with an air line of an automated pressure monitoring apparatus.

In some instances, the mechanism for selectively contacting the first air chamber is configured to contact the first air chamber to provide a simulated pulse. The mechanism for selectively contacting the first air chamber may be configured to contact the first air chamber with varying amounts of force to provide the simulated pulse. The mechanism for selectively contacting the first air chamber may comprise a second air chamber. The system may further comprise a housing positioned within the patient simulator and the first air chamber and the second air chamber may be positioned within the housing. In some aspects, the first air chamber comprises a first bellow and the second air chamber comprises a second bellow.

The system may also include an air supply and at least one valve in communication with the air supply and the second air chamber. The at least one valve may be configured to connect the air supply to the second air chamber and connect the second air chamber to atmosphere. The air supply can include a compressor, compressed gas/air canister, or other source of gas/air. The at least one valve can include a single valve configured to connect the air supply to the second air chamber in a first position and connect the second air chamber to atmosphere in a second position. The at least one valve can include a first valve for connecting the air supply to the second air chamber and a second valve for connecting the second air chamber to atmosphere.

The system can also include at least one processor in communication with the air supply and the at least one valve. The processor may be configured to control actuation of the at least one valve to cause the second air chamber to selectively contact the first air chamber to provide the simulated pulse. The at least one processor may be configured to cause the second air chamber to selectively contact the first air chamber with varying amounts of force to provide the simulated pulse. The at least one processor may be in communication with the air pressure sensor and further configured to cause the second air chamber to selectively contact the first air chamber with varying amounts of force to provide the simulated pulse based on a simulated blood pressure of the patient simulator. The simulated blood pressure may set by a user, set based on a simulation profile, and/or combinations thereof.

In some instances, the simulated body portion includes a simulated arm. The air pressure sensor may be positioned within an upper portion of the simulated arm. The first air chamber may be positioned within the simulated arm or remote from the simulated arm. Further, the air pressure sensor, the air supply, the one or more valves, the one or more processors, the housing, the first and/or second air chambers, the first and/or second bellows, may be positioned within the simulated arm or remote from the simulated arm. In some instances, at least the air pressure sensor, the air supply, the one or more valves, the housing, and the first and second air chambers are positioned within the simulated arm.

In some aspects, the adapter is configured to connect the air pressure sensor to the air line of the automated pressure monitoring apparatus such that the air pressure sensor can monitor an air pressure generated by the automated pressure monitoring apparatus. The adapter may be in communication with the air pressure sensor via tubing. That is, one or more flexible and/or rigid tubes may connect the air pressure sensor to the adapter.

The system may further comprise the automated pressure monitoring apparatus. The automated pressure monitoring system may comprise a cuff, a monitor, and the air line. The adapter may be coupled with the air line such that the cuff and the monitor are in fluid communication through the air line and the adapter. In some instances, the adapter may be coupled to a first portion of the air line extending between the adapter and the monitor and coupled to a second portion of the air line extending between the adapter and the cuff

In some aspects of the present disclosure, a method of teaching patient care is provided. The method may include providing a patient simulator having a simulated body portion, an air pressure sensor, a first air chamber, and a mechanism for selectively contacting the first air chamber; connecting an air line of an automated pressure monitoring apparatus to the air pressure sensor of the patient simulator; and simulating a blood pressure of the patient simulator using at least the air pressure sensor, the first air chamber, and the mechanism for selectively contacting the first air chamber. Simulating the blood pressure of the patient simulator may comprises simulating a pulse of the patient simulator by selectively contacting the first air chamber with the mechanism for selectively contacting the first air chamber. In this regard, the mechanism for selectively contacting the first air chamber may comprise a second air chamber. In some instances, the first air chamber and the second air chamber are positioned within a housing within the patient simulator. The first air chamber may comprise a first bellow and the second air chamber may comprise a second bellow.

In some instances, the patient simulator further comprises an air supply and at least one valve in communication with the air supply and the second air chamber, wherein the at least one valve is configured to connect the air supply to the second air chamber and connect the second air chamber to atmosphere. In such instances, simulating the blood pressure of the patient simulator may further comprise using the air supply and the at least one valve to simulate the blood pressure. In this regard, simulating the blood pressure of the patient simulator may include selectively inflating and deflating the second air chamber using the air supply and the at least one valve. Selectively inflating and deflating the second air chamber using the air supply and the at least one valve may comprise moving the valve between a first position connecting the air supply to the second air chamber and a second position connecting the second air chamber to atmosphere. Selectively inflating and deflating the second air chamber using the air supply and the at least one valve may comprise selectively opening and closing a first valve connecting the air supply to the second air chamber and selectively opening and closing a second valve connecting the second air chamber to atmosphere. Simulating the pulse of the patient simulator by selectively contacting the first air chamber with the mechanism for selectively contacting the first air chamber may comprise controlling actuation of the at least one valve to cause the second air chamber to selectively contact the first air chamber to provide the simulated pulse. In some instances, the actuation of the at least one valve is controlled in a manner to cause the second air chamber to selectively contact the first air chamber with varying amounts of force to provide the simulated pulse. In this regard, the actuation of the at least one valve may be based on a simulated blood pressure of the patient simulator. The simulated blood pressure may set by a user, set based on a simulation profile, and/or combinations thereof.

The simulated body portion may include a simulated arm and the air pressure sensor may be positioned within an upper portion of the simulated arm and the method may further comprise positioning a cuff of the automated pressure monitoring apparatus around the simulated arm. The cuff may be in communication with the air line of the automated pressure monitoring apparatus. Connecting the air line of the automated pressure monitoring apparatus to the air pressure sensor of the patient simulator may comprises connecting an adapter to the air line of the automated pressure monitoring apparatus such that the air pressure sensor can monitor an air pressure generated by the automated pressure monitoring apparatus. Connecting the air line of the automated pressure monitoring apparatus to the air pressure sensor of the patient simulator may further comprise extending tubing between the adapter and the air pressure sensor. Connecting the adapter to the air line of the automated pressure monitoring apparatus may comprise coupling a first portion of the air line extending from a monitor of the automated pressure monitoring apparatus to the adapter and coupling a second portion of the air line extending from a cuff of the automated pressure monitoring apparatus to the adapter.

In another embodiment an apparatus comprises a simulated arm configured to interface with an automated blood monitoring apparatus such that a simulated blood pressure of the simulated arm is measurable by the automated blood pressure monitoring apparatus. The simulated arm may include features similar to those described in the context of the systems and methods above in addition to the further details and examples provided in the detailed description below. In this regard, the simulated arm may be used in a stand-alone manner and/or attached to a simulated torso of a patient simulator.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator incorporating aspects of the present disclosure.

FIG. 2 is a diagrammatic schematic view of a portion of the patient simulator of FIG. 1 interfacing with an external automatic blood pressure monitoring apparatus according to aspects of the present disclosure.

FIG. 3 provides graphical representations of sound, air pressure, air pressure oscillations, and pulses associated with simulating blood pressure in the context of an external automatic blood pressure monitoring apparatus according to aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

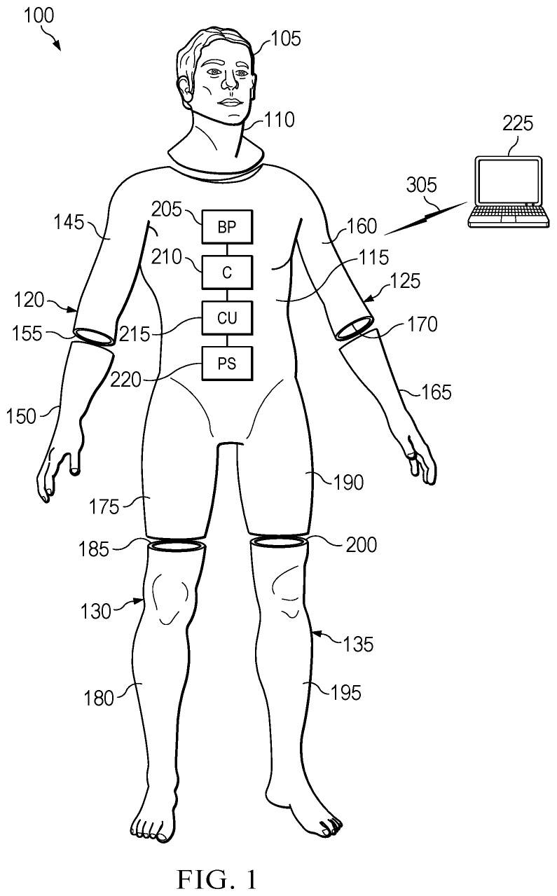

Referring to FIG. 1, a patient simulator 100 in accordance with the present disclosure may include a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 is coupled to the simulated neck 110; for example, the simulated head 105 may be releasably coupled and/or integrally formed with the simulated neck 110. The simulated neck 110 may be releasably coupled and/or integrally formed with the simulated torso 115. The simulated right arm 120 includes a simulated upper right arm 145 (or “extremity”) and a simulated lower right arm 150 (or “extremity”). The simulated upper right arm 145 may be releasably coupled and/or integrally formed with the simulated torso 115. The simulated lower right arm 150 may be releasably coupled and/or integrally formed with the simulated upper right arm 145. In some instances, the simulated lower right arm 150 is coupled with the simulated upper right arm 145 via a right arm coupling 155. Similarly, the simulated left arm 125 includes a simulated upper left arm 160 (or “extremity”) and a simulated lower left arm 165 (or “extremity”). The simulated upper left arm 160 may be releasably coupled and/or integrally formed with the simulated torso 115. The simulated lower left arm 165 may be releasably coupled and/or integrally formed with the simulated upper left arm 160. In some instances, the simulated lower left arm 165 is coupled with the simulated upper left arm 160 via a left arm coupling 170.

The simulated right leg 130 includes a simulated upper right leg 175 (or “extremity”) and a simulated lower right leg 180 (or “extremity”). The simulated upper right leg 175 may be releasably coupled and/or integrally formed with the simulated torso 115. The simulated lower right leg 180 may be releasably coupled and/or integrally formed with the simulated upper right leg 175. In some instances, the simulated lower right leg 180 is coupled with the simulated upper right leg 175 via a right leg coupling 185. Similarly, the simulated left leg 135 includes a simulated upper left leg 190 (or “extremity”) and a simulated lower left leg 195 (or “extremity”). The simulated upper left leg 190 may be releasably coupled and/or integrally formed with the simulated torso 115. The simulated lower left leg 195 may be releasably coupled and/or integrally formed with the simulated upper left leg 190. In some instances, the simulated lower left leg 195 is coupled with the simulated upper left leg 190 via a left leg coupling 200.

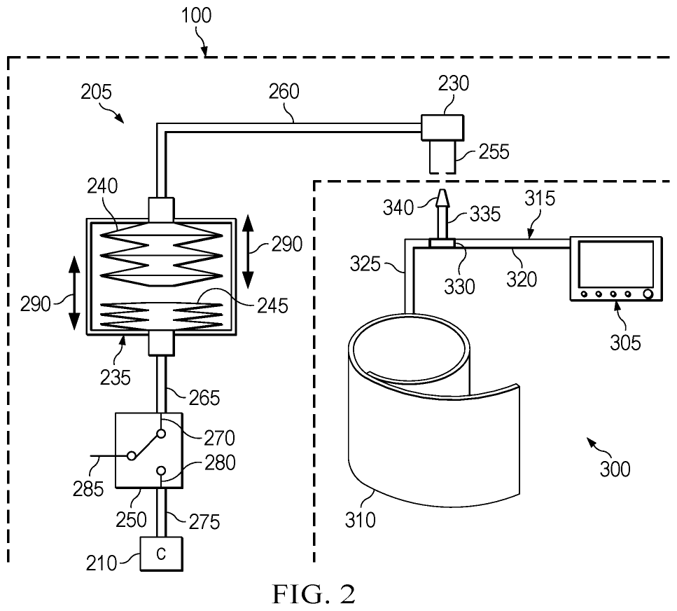

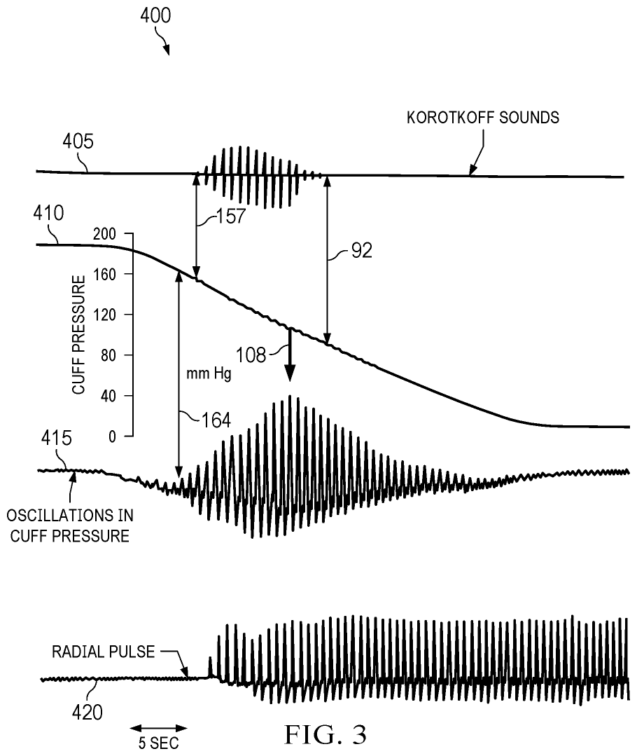

The patient simulator 100 can include one or more of an automatic blood pressure monitoring module 205, a compressor 210, a control unit 215, and/or a power source 220. In some instances, the compressor 210, the control unit 215, and/or the power source 220 may be components of the automatic blood pressure monitoring module 205. As will be described in greater detail below, the automated blood pressure monitoring module 205 may be configured to interface with an external automated blood pressure monitoring apparatus in order simulate blood pressure, pulses, and/or sounds associated with the patient simulator 100. For example, in some instances the automatic blood pressure monitoring module 205 of the patient simulator 100 may be configured to generate simulated pulses in an air line of the automated blood pressure monitoring apparatus based on a desired blood pressure of the patient simulator. For example, the automatic blood pressure monitoring module 205 of the patient simulator 100 may monitor an air pressure generated by the automated blood pressure monitoring apparatus and generate oscillations in the pressure of the air line to simulate pulses (e.g., brachial and/or radial pulses) in accordance with the desired simulated blood pressure of the patient simulator. Additional features and aspects of the automatic blood pressure monitoring module 205 and the interaction between the patient simulator 100 and an automatic blood pressure monitoring apparatus are described below in the context of FIGS. 2 and 3.

The compressor 210 may be adapted to supply pneumatic pressure to various features/components of the patient simulator 100, including components of the automatic blood pressure monitoring module 205. Such features/components to which pneumatic pressure is supplied by the compressor 210 may be contained in the simulated torso 115, the simulated head 105, the simulated right arm 120, the simulated left arm 125, the simulated right leg 130, and/or the simulated left leg 135. In some instances, the compressor 210 is a scroll compressor.

The control unit 215 may be adapted to control aspects and/or components of the automatic blood pressure monitoring module 205, the compressor 210, and/or various other features/components of the patient simulator 100 that may be contained in the simulated torso 115, the simulated head 105, the simulated right arm 120, the simulated left arm 125, the simulated right leg 130, and/or the simulated left leg 135. In some instances, the control unit 215 is configured to control aspects and/or components of the automatic blood pressure monitoring module 205, the compressor 210, and/or various other features/components of the patient simulator 100 based on inputs from a controller 225 in communication with the patient simulator 100. The controller 225 may be in wireless (RF, Wi-Fi, Bluetooth, optical, etc.) and/or wired communication with the patient simulator 100. In this regard, the patient simulator 100 may be configured to simulate one or more parameters in response to settings and/or programs of the controller 225. In this regard, the one or more parameters may be based on user inputs, a simulation profile, and/or a combination thereof. For example, in some instances, a simulated blood pressure and/or pulse of the patient simulator 100 may be set by a user, a simulation profile defined by or running on the controller 225, and/or combinations thereof. In this regard, the controller 225 may include a plurality of pre-programmed and/or custom simulation profiles that are each configured to set the simulated blood pressure and/or pulse of the patient simulator 100 (along with other parameters) over time. The simulation profile(s) may cause the particular values of the simulated blood pressure and/or pulse of the patient simulator 100 to change over time in accordance with a simulated medical scenario. In some instances, the simulation profile(s) may adjust the values of the simulated blood pressure and/or pulse of the patient simulator 100 over time based at least in part on actions and/or interventions taken by a user to treat the patient simulator.

The power source 220 may be adapted to supply electrical power to the automatic blood pressure monitoring module 205, the compressor 210, the control unit 215, and/or various other features/components of the patient simulator 100 that may be contained in the simulated torso 115, the simulated head 105, the simulated right arm 120, the simulated left arm 125, the simulated right leg 130, and/or the simulated left leg 135. The power source 220 may include one or more batteries, capacitors, and/or other power storage components. The power source 220 may also include one or more controllers, processors, application specific integrated circuits (ASICs), amplifiers, switches, and/or other components configured to control the distribution of power to the various components of the patient simulator.

It is understood that the illustrated embodiment of the patient simulator 100 is sized and shaped to represent a patient that will receive treatment. In that regard, the patient simulator can take a variety of forms, including a manikin sized and shaped to represent male or female patients of any size, age, and/or health, ranging from premature fetus to full-sized adults. Further, the patient simulator may include only a portion of the simulated patient (e.g., specific body parts or combinations of body parts). Accordingly, while aspects of the present disclosure are described with respect to particular embodiments of patient simulators, no limitation is intended thereby. It is understood that the features of the present disclosure may be incorporated into or utilized in conjunction with any suitable patient simulators. In some instances, aspects of the present disclosure are configured for use with the simulators and the related features disclosed in U.S. patent application Ser. No. 11/952,559 (Publication No. 20080138778), U.S. patent application Ser. No. 11/952,606 (Publication No. 20080131855), U.S. patent application Ser. No. 11/952,636 (Publication No. 20080138779), U.S. patent application Ser. No. 11/952,669 (Publication No. 20090148822), U.S. patent application Ser. No. 11/952,698 (Publication No. 20080138780), U.S. Pat. Nos. 7,114,954, 6,758,676, 6,503,087, 6,527,558, 6,443,735, 6,193,519, and 5,853,292, each herein incorporated by reference in its entirety.

Referring now to FIG. 2, shown therein are additional aspects of the patient simulator 100 according to aspects of the present disclosure. In this regard, FIG. 2 is a diagrammatic schematic view of a portion of the patient simulator 100 interfacing with an external automatic blood pressure monitoring apparatus 300 according to aspects of the present disclosure. As shown, a portion of the patient simulator 100 includes components of the automated blood pressure monitoring module 205. In some instances, one or more components of the automated blood pressure monitoring module 205 are positioned within the left arm 125 (e.g., the upper left arm 160 and/or the lower left arm 165) and/or the torso 115 of the patient simulator 100. However, one or more components of the automated blood pressure monitoring module 205 may be positioned within other portions of the patient simulator 100 as well. As shown, in the illustrated example the automated blood pressure monitoring module 205 includes a sensor 230, a housing 235 containing a first bellow 240 and a second bellow 245, and a valve 250. The valve 250 may be in communication with an air supply (e.g., a compressor, compressed gas/air canister, or other source of gas/air). In the illustrated example, the valve 250 is in communication with the compressor 210. The automated blood pressure monitoring module may be configured to provide brachial artery simulation for non-invasive blood pressure monitoring as described below.

In some instances, the automated blood pressure monitoring module 205 may include one or more connectors, adapters, ports, tubes, and/or other couplings to facilitate pneumatic connections between the sensor 230, the first bellow 240, and/or the external automatic blood pressure monitoring apparatus 300 and/or pneumatic connections between the air supply (e.g., compressor 210), the valve 250, and/or the second bellow 245. In the illustrated example, a port 255 provides a pneumatic connection to the external automatic blood pressure monitoring apparatus 300. In some instances, the port 255 is positioned adjacent to and/or flush with a skin surface of the patient simulator 100 to allow connection by an external plug or connector configured to mate with the port 255. In some instances, the port 255 may be integrated with the sensor 230 and/or coupled to the sensor 230. A tubing 260 extends between the sensor 230 and the first bellow 240. In some instances, the tubing 260 may couple to a port of the housing 235 that is coupled to the first bellow 240. A tubing 265 extends between the second bellow 245 and the valve 250. In some instances, the tubing 265 may couple to a port of the housing 235 that is coupled to the second bellow 240. In some instances, the tubing 265 may couple directly or indirectly to a port 270 of the valve 250. A tubing 275 extends between the valve 250 and the compressor 210. In some instances, the tubing 275 may couple directly or indirectly to a port 280 of the valve 250. As will be discussed below, the valve 250 may also include a port 285. The port 285 may be open to atmosphere to allow the release of air from the second bellow 245. In this regard, in some instances the port 285 may open directly or indirectly (e.g., via one or more tubings, connectors, etc.) to a space within the patient simulator 100. In other instances, the port 285 may open directly or indirectly to a space outside the patient simulator 100.

As shown, the external automatic blood pressure monitoring apparatus 300 may include a monitor 305 and a cuff 310. The monitor 305 may be pneumatically connected to the cuff via air line 315. In this regard, the air line 315 may be at least partially defined by a first tubing portion 320 and a second tubing portion 325. In some instances, the first tubing portion 320 and the second tubing portion 325 are from a single piece of tubing or other material that is cut or otherwise separated to form the two separate portions. The first tubing portion 320 of the air line 315 may extend between the monitor 305 and an adapter 330. The adapter 330 may be configured to allow the automated blood pressure monitoring module 205 of the patient simulator 100 to interface with the external automatic blood pressure monitoring apparatus 300. For example, in the illustrated example the adapter 330 facilitates the connection of a tubing 335 to the port 255 of the patient simulator 100 such that the sensor 230 can monitor an air pressure in the air line 315 generated by the monitor 305. In some instances, the adapter 330 may include one or more connectors, such as a t-connector, y-connector, and/or other suitable connector(s) to allow the sensor 230 to monitor the air pressure generated in the air line 315 by the external automatic blood pressure monitoring apparatus 300. In some instances, the first tubing portion 320 and the second tubing portion 325 are part of a single piece of tubing or other material and the adapter 330 is configured to engage with the air line 315 through an opening in a sidewall and/or connector of the single piece of tubing or other material. An external plug or connector 340 coupled to the tubing 335 may be configured to mate with the port 255 to provide the pneumatic connection between the automated blood pressure monitoring module 205 and the external automatic blood pressure monitoring apparatus 300. The sensor 230 may include a pressure sensor, load sensor, and/or other suitable sensor for monitoring the air pressure within the air line 315 (e.g., via adapter 330 and tubing 335 and/or other suitable connections).

In use, the automated blood pressure monitoring module 205 may be utilized to simulate a blood pressure (including systolic and diastolic blood pressures) and/or pulse of the patient simulator 100. In this regard, the automated blood pressure monitoring module 205 may be configured to allow the blood pressure and/or pulse of the patient simulator 100 to be taken using external automated blood pressure systems. In this regard, the sensor 230 may be configured to monitor an air pressure generated by the automated blood pressure monitoring system 300 and a mechanism of the automated blood pressure monitoring module 205 may be configured to cause a simulated pulse in the air line 315 of the automated blood pressure monitoring system 300. In this regard, the automated blood pressure monitoring module 205 of the patient simulator 100 may be configured to generate simulated pulses in the air line 315 of the automated blood pressure monitoring apparatus based on a desired blood pressure and/or pulse of the patient simulator 100. For example, the patient simulator 100 may monitor the air pressure generated by the automated blood pressure monitoring system 300 and generate oscillations in the pressure of the air line 315 to simulate pulses (e.g., brachial and/or radial pulses) in accordance with the desired simulated blood pressure.

Generally speaking, the automated blood pressure monitoring system 300 may generate an initial air pressure at a value corresponding to a blood pressure significantly higher than expected for a patient (e.g., >200-250 mmHg) and then slowly decreases the initial air pressure while monitoring the pressure in the air line 315, including oscillations caused by the pulse of the patient, in order to determine the patient's blood pressure. More specifically, the automated blood pressure monitoring system 300 can utilize the air pressure in the air line 315 and the strength of the oscillations caused by the pulses to determine the systolic and diastolic blood pressures for the patient. In accordance with aspects of the present disclosure, the strength of the oscillations induced in the air line 315 of the automated blood pressure monitoring system 300 caused by the mechanism for causing the simulated pulses can be modified as the air pressure generated by the automated blood pressure monitoring system 300 decreases (e.g., as monitored by the sensor 230) in order to simulate pulse patterns consistent with the desired systolic and diastolic blood pressures.

In the illustrated example of FIG. 2, the mechanism for causing the simulated pulses in the air line 315 of the automated blood pressure monitoring system 300 includes the second bellow 245 selectively contacting the first bellow 240. However, in other instances other mechanisms (e.g., mechanical, pneumatic, and/or combinations thereof) may be utilized to impart the simulated pulses in the air line. For example, in some instances the second bellow 245 may be replaced with a mechanical component (e.g., piston) driven pneumatically, by an electrical motor, and/or other suitable movement generating component to selectively contact the first bellow 240. In some instances, a mechanical component (e.g., a piston) driven pneumatically, by an electrical motor, and/or other suitable movement generating component selectively contacts a flexible tubing (e.g., similar to tubing 260) to impart oscillations in the air line 315. Further, in some instances the first bellow 240 and/or the second bellow 245 may be replaced with other types of air chambers, including without limitation balloons, flexible membranes, pistons, and/or combinations thereof.

In the illustrated example of FIG. 2, the first bellow 240 will be inflated as the automated blood pressure monitoring system 300 generates the initial air pressure in the air line 315 since the first bellow 240 is in pneumatic communication with the air line 315 via the adapter 330, the tubing 335, the sensor 230, and the tubing 260. The housing 235 may be sized and shaped to ensure that the first bellow 240 expands (and contracts) generally in the direction of arrow 290. That is, the first bellow 240 may expand toward the second bellow 245 (downward in FIG. 2) when inflated and retract away from the second bellow 245 (upward in FIG. 2) when deflated. In some instances, the housing 235 is cylindrical and formed of a rigid plastic and/or metal such that the housing is not deformed by inflation of the first bellow 240 and/or the second bellow 245. In other instances, the housing 235 may utilize other configurations and/or materials, including without limitation a rectangular box, a cube, a rounded rectangular box, a rounded cube, sphere, etc. and/or flexible plastic, flexible metal, cloth, woven fibers, linked connectors forming a chamber, etc., including combinations thereof.

The automated blood pressure monitoring module 205 may selectively inflate and deflate the second bellow 245 to cause the second bellow 245 to contact the first bellow 245 and, thereby, impart oscillations to the air line 315 of the automated blood pressure monitoring system 300. In this regard, the second bellow 245 may be inflated by the air supply (e.g., compressor 210) by the valve 250 connecting the port 270 to the port 280 such that air from the air supply is passed into the second bellow 245. The valve 250 connecting the port 270 to the port 280 may be considered a first position of the valve. The second bellow 245 may be deflated by releasing air from the second bellow 245. For example, in some instances air is released from the second bellow 245 by the valve 250 connecting the port 270 to the port 285 such that air from the second bellow 245 is related to atmosphere (e.g., inside or outside of the patient simulator 100). The valve 250 connecting the port 270 to the port 285 may be considered a second position of the valve. The housing 235 may be sized and shaped to ensure that the second bellow 245 expands (and contracts) generally in the direction of arrow 295. That is, the second bellow 245 may expand toward the first bellow 240 (upward in FIG. 2) when inflated and retract away from the first bellow 240 (downward in FIG. 2) when deflated.

The automated blood pressure monitoring module 205 may control the position(s) of the valve 250 in order to selectively inflate and deflate the second bellow 245 to impart oscillations to the air line 315 of the automated blood pressure monitoring system 300. In this regard, the strength of an oscillation may be controlled by the amount of time the valve 250 is in the first position where ports 270 and 280 are connected. For example, the longer the valve 250 is in the first position where ports 270 and 280 are connected, the greater the amount of air supplied to the second bellow 245 will be. As more compressed air is supplied to the second bellow, the greater the second bellow 245 will inflate. The more the second bellow 245 inflates, the greater contact the second bellow 245 will have with the first bellow 240. The greater the contact between the second bellow 245 and the first bellow 240, the greater the deformation in the bellow 240 and, therefore, the greater the oscillation in the air line 315 of the automated blood pressure monitoring system 300. Accordingly, by controlling the amount of time the valve 250 spends in the first position (connecting ports 270 and 280) and the second position (connecting ports 270 and 285) the automated blood pressure monitoring module 205 can generate oscillations in the air line 315 of the automated blood pressure monitoring system 300 corresponding to the desired simulated blood pressure and/or pulse of the patient simulator. In this regard, FIG. 3 provides a set of graphical representations 400 showing exemplary relationships between sound 405, air pressure 410, air pressure oscillations 415, and pulses 420 associated with simulating blood pressure in the context of an external automatic blood pressure monitoring apparatus according to aspects of the present disclosure.

The automated blood pressure monitoring module 205 can be calibrated such that a blood pressure measurement and/or pulse measured by the external automated blood pressure monitoring apparatus 300 corresponds to the desired simulated blood pressure and/or pulse of the patient simulator 100. In this regard, the automated blood pressure monitoring module 205 and/or the control unit 215 may be programmable via a user interface in some instances. In some embodiments, the user interface is computer based and may be part of an overall user interface for controlling various aspects of the patient simulator 100. In this regard, in some instances the controller 225 (FIG. 1) or similar device may be utilized to execute a calibration procedure where multiple different simulated blood pressures and/or simulated pulses are simulated by the patient simulator 100. The corresponding blood pressure and/or pulse measurements as measured by the external automated blood pressure monitoring apparatus 300 can be manually or automatically input to the controller 225 (or another device). By comparing the measured blood pressure and/or pulse values to the desired simulated blood pressure and/or pulse values, the controller 225 (or other device) and/or the automated blood pressure monitoring module 205 can determine adjustments to make (e.g., to the valve activation time(s), to a mapping of air pressure measurements as measured by the sensor to desired simulated blood pressure values, combinations thereof, etc.) to ensure that the blood pressure and/or pulses simulated by the patient simulator 100 match the values as measured by the external automated blood pressure monitoring apparatus 300. The calibration procedure may be repeated multiple times and/or periodically to ensure that the measurements of the external automated blood pressure monitoring apparatus 300 match the desired simulated blood pressure and/or pressure values.

In some instances, the patient simulator 100 is further configured to produce one or more sounds based on the simulated blood pressure. For example, the one or more sounds may include Korotkoff sounds, brachial pulse, radial pulse, and other related blood pressure related sounds. The patient simulator may include one or more speakers for producing the one or more sounds in some instances. The one or more sounds based on the simulated blood pressure may be coordinated with the simulated pulses in the air line 315 of the automated blood pressure monitoring system 300 in accordance with the desired blood pressure of the patient simulator.

In some instances, the measurements of the sensor 230 are utilized to determine when certain sounds should be produced by the patient simulator 100. For example, in some instances the measurements of the sensor 230 are utilized to determine when to play Korotkoff sounds. Further, sounds associated with the brachial and/or radial pulses may cut off per the desired systolic and diastolic pressures of the patient simulator 100. In this regard, the automated blood pressure monitoring module 205 and/or the control unit 215 may be in communication with another module or controller for producing these various sounds. Alternatively, the automated blood pressure monitoring module 205 and/or the control unit 215 may control a speaker or speakers for producing these sounds. In this manner, the sensor 230 and related components of the automated blood pressure monitoring module 205 may be utilized to allow a user to take the simulated blood pressure of the patient simulator in a realistic manner utilizing an external automated blood pressure monitoring system, but also still allow the user to monitor the typical sounds associated with blood pressure measurements with a stethoscope or other monitoring device.

In some aspects of the present disclosure, a system comprises: a patient simulator having a simulated body portion; an air pressure sensor positioned within the simulated body portion; a first air chamber positioned within the patient simulator, the first air chamber in communication with the air pressure sensor; a mechanism for selectively contacting the first air chamber; and an adapter positioned outside the patient simulator, the adapter in communication with the air pressure sensor and configured to be in communication with an air line of an automated pressure monitoring apparatus.

In some instances, the mechanism for selectively contacting the first air chamber is configured to contact the first air chamber to provide a simulated pulse. The mechanism for selectively contacting the first air chamber may be configured to contact the first air chamber with varying amounts of force to provide the simulated pulse. The mechanism for selectively contacting the first air chamber may comprise a second air chamber. The system may further comprise a housing positioned within the patient simulator and the first air chamber and the second air chamber may be positioned within the housing. In some aspects, the first air chamber comprises a first bellow and the second air chamber comprises a second bellow.

The system may also include an air supply and at least one valve in communication with the air supply and the second air chamber. The at least one valve may be configured to connect the air supply to the second air chamber and connect the second air chamber to atmosphere. The air supply can include a compressor, compressed gas/air canister, or other source of gas/air. The at least one valve can include a single valve configured to connect the air supply to the second air chamber in a first position and connect the second air chamber to atmosphere in a second position. The at least one valve can include a first valve for connecting the air supply to the second air chamber and a second valve for connecting the second air chamber to atmosphere.

The system can also include at least one processor in communication with the air supply and the at least one valve. The processor may be configured to control actuation of the at least one valve to cause the second air chamber to selectively contact the first air chamber to provide the simulated pulse. The at least one processor may be configured to cause the second air chamber to selectively contact the first air chamber with varying amounts of force to provide the simulated pulse. The at least one processor may be in communication with the air pressure sensor and further configured to cause the second air chamber to selectively contact the first air chamber with varying amounts of force to provide the simulated pulse based on a simulated blood pressure of the patient simulator. The simulated blood pressure may set by a user, set based on a simulation profile, and/or combinations thereof.

In some instances, the simulated body portion includes a simulated arm. The air pressure sensor may be positioned within an upper portion of the simulated arm. The first air chamber may be positioned within the simulated arm or remote from the simulated arm. Further, the air pressure sensor, the air supply, the one or more valves, the one or more processors, the housing, the first and/or second air chambers, the first and/or second bellows, may be positioned within the simulated arm or remote from the simulated arm. In some instances, at least the air pressure sensor, the air supply, the one or more valves, the housing, and the first and second air chambers are positioned within the simulated arm.

In some aspects, the adapter is configured to connect the air pressure sensor to the air line of the automated pressure monitoring apparatus such that the air pressure sensor can monitor an air pressure generated by the automated pressure monitoring apparatus. The adapter may be in communication with the air pressure sensor via tubing. That is, one or more flexible and/or rigid tubes may connect the air pressure sensor to the adapter.

The system may further comprise the automated pressure monitoring apparatus. The automated pressure monitoring system may comprise a cuff, a monitor, and the air line. The adapter may be coupled with the air line such that the cuff and the monitor are in fluid communication through the air line and the adapter. In some instances, the adapter may be coupled to a first portion of the air line extending between the adapter and the monitor and coupled to a second portion of the air line extending between the adapter and the cuff

In some aspects of the present disclosure, a method of teaching patient care is provided. The method may include providing a patient simulator having a simulated body portion, an air pressure sensor, a first air chamber, and a mechanism for selectively contacting the first air chamber; connecting an air line of an automated pressure monitoring apparatus to the air pressure sensor of the patient simulator; and simulating a blood pressure of the patient simulator using at least the air pressure sensor, the first air chamber, and the mechanism for selectively contacting the first air chamber. Simulating the blood pressure of the patient simulator may comprises simulating a pulse of the patient simulator by selectively contacting the first air chamber with the mechanism for selectively contacting the first air chamber. In this regard, the mechanism for selectively contacting the first air chamber may comprise a second air chamber. In some instances, the first air chamber and the second air chamber are positioned within a housing within the patient simulator. The first air chamber may comprise a first bellow and the second air chamber may comprise a second bellow.

In some instances, the patient simulator further comprises an air supply and at least one valve in communication with the air supply and the second air chamber, wherein the at least one valve is configured to connect the air supply to the second air chamber and connect the second air chamber to atmosphere. In such instances, simulating the blood pressure of the patient simulator may further comprise using the air supply and the at least one valve to simulate the blood pressure. In this regard, simulating the blood pressure of the patient simulator may include selectively inflating and deflating the second air chamber using the air supply and the at least one valve. Selectively inflating and deflating the second air chamber using the air supply and the at least one valve may comprise moving the valve between a first position connecting the air supply to the second air chamber and a second position connecting the second air chamber to atmosphere. Selectively inflating and deflating the second air chamber using the air supply and the at least one valve may comprise selectively opening and closing a first valve connecting the air supply to the second air chamber and selectively opening and closing a second valve connecting the second air chamber to atmosphere. Simulating the pulse of the patient simulator by selectively contacting the first air chamber with the mechanism for selectively contacting the first air chamber may comprise controlling actuation of the at least one valve to cause the second air chamber to selectively contact the first air chamber to provide the simulated pulse. In some instances, the actuation of the at least one valve is controlled in a manner to cause the second air chamber to selectively contact the first air chamber with varying amounts of force to provide the simulated pulse. In this regard, the actuation of the at least one valve may be based on a simulated blood pressure of the patient simulator. The simulated blood pressure may set by a user, set based on a simulation profile, and/or combinations thereof.

The simulated body portion may include a simulated arm and the air pressure sensor may be positioned within an upper portion of the simulated arm and the method may further comprise positioning a cuff of the automated pressure monitoring apparatus around the simulated arm. The cuff may be in communication with the air line of the automated pressure monitoring apparatus. Connecting the air line of the automated pressure monitoring apparatus to the air pressure sensor of the patient simulator may comprises connecting an adapter to the air line of the automated pressure monitoring apparatus such that the air pressure sensor can monitor an air pressure generated by the automated pressure monitoring apparatus. Connecting the air line of the automated pressure monitoring apparatus to the air pressure sensor of the patient simulator may further comprise extending tubing between the adapter and the air pressure sensor. Connecting the adapter to the air line of the automated pressure monitoring apparatus may comprise coupling a first portion of the air line extending from a monitor of the automated pressure monitoring apparatus to the adapter and coupling a second portion of the air line extending from a cuff of the automated pressure monitoring apparatus to the adapter.

In another embodiment an apparatus comprises a simulated arm configured to interface with an automated blood monitoring apparatus such that a simulated blood pressure of the simulated arm is measurable by the automated blood pressure monitoring apparatus. The simulated arm may include features similar to those described in the context of the systems and methods above in addition to the further details and examples provided in the detailed description below. In this regard, the simulated arm may be used in a stand-alone manner and/or attached to a simulated torso of a patient simulator.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

What is claimed is:

1. A system, comprising:
a patient simulator having a simulated body portion;
an air pressure sensor positioned within the simulated body portion;
a first air chamber positioned within the patient simulator, the first air chamber in communication with the air pressure sensor;
a mechanism for selectively contacting the first air chamber; and
an adapter positioned outside the patient simulator, the adapter in communication with the air pressure sensor and configured to be in communication with an air line of an automated pressure monitoring apparatus.

2. The system of claim 1, wherein the mechanism for selectively contacting the first air chamber is configured to contact the first air chamber to provide a simulated pulse.

3. The system of claim 2, wherein the mechanism for selectively contacting the first air chamber comprises a second air chamber.

4. The system of claim 3, further comprising:
a housing positioned within the patient simulator, wherein the first air chamber and the second air chamber are positioned within the housing.

5. The system of claim 4, wherein the first air chamber comprises a first bellow and the second air chamber comprises a second bellow.

6. The system of claim 3, further comprising:
an air supply; and
at least one valve in communication with the air supply and the second air chamber, wherein the at least one valve is configured to connect the air supply to the second air chamber and connect the second air chamber to atmosphere.

7. The system of claim 6, wherein the air supply includes a compressor.

8. The system of claim 6, wherein the at least one valve comprises a single valve configured to connect the air supply to the second air chamber in a first position and connect the second air chamber to atmosphere in a second position.

9. The system of claim 6, wherein the at least one valve comprises a first valve for connecting the air supply to the second air chamber and a second valve for connecting the second air chamber to atmosphere.

10. The system of claim 6, further comprising:
at least one processor in communication with the air supply and the at least one valve, the processor configured to control actuation of the at least one valve to cause the second air chamber to selectively contact the first air chamber to provide the simulated pulse.

11. The system of claim 10, wherein the at least one processor is configured to cause the second air chamber to selectively contact the first air chamber with varying amounts of force to provide the simulated pulse.

12. The system of claim 10, wherein the at least one processor is in communication with the air pressure sensor and further configured to cause the second air chamber to selectively contact the first air chamber with varying amounts of force to provide the simulated pulse based on a simulated blood pressure of the patient simulator.

13. The system of claim 12, wherein the simulated blood pressure is set by a user.

14. The system of claim 12, wherein the simulated blood pressure is set by the at least one processor based on a simulation profile.

15. The system of claim 2, wherein the mechanism for selectively contacting the first air chamber is configured to contact the first air chamber with varying amounts of force to provide the simulated pulse.

16. The system of claim 1, wherein the simulated body portion includes a simulated arm.

17. The system of claim 16, wherein the air pressure sensor is positioned within an upper portion of the simulated arm.

18. The system of claim 16, wherein the first air chamber is positioned within the simulated arm.

19. The system of claim 1, wherein the adapter is configured to connect the air pressure sensor to the air line of the automated pressure monitoring apparatus such that the air pressure sensor can monitor an air pressure generated by the automated pressure monitoring apparatus.

20. The system of claim 19, wherein the adapter is in communication with the air pressure sensor via tubing.

21. The system of claim 1, further comprising the automated pressure monitoring apparatus, wherein:
the automated pressure monitoring system comprises a cuff, a monitor, and the air line; and
the adapter is coupled with the air line such that the cuff and the monitor are in fluid communication through the air line and the adapter.

22. The system of claim 21, wherein the adapter is coupled to a first portion of the air line extending between the adapter and the monitor and coupled to a second portion of the air line extending between the adapter and the cuff.

23. A method, comprising:
providing a patient simulator having a simulated body portion, an air pressure sensor, a first air chamber, and a mechanism for selectively contacting the first air chamber;
connecting an air line of an automated pressure monitoring apparatus to the air pressure sensor of the patient simulator; and
simulating a blood pressure of the patient simulator using at least the air pressure sensor, the first air chamber, and the mechanism for selectively contacting the first air chamber.

24. The method of claim 23, wherein the simulating the blood pressure of the patient simulator comprises:
simulating a pulse of the patient simulator by selectively contacting the first air chamber with the mechanism for selectively contacting the first air chamber.

25. The method of claim 24, wherein the mechanism for selectively contacting the first air chamber comprises a second air chamber.

26. The method of claim 25, wherein the first air chamber and the second air chamber are positioned within a housing within the patient simulator.

27. The method of claim 26, wherein the first air chamber comprises a first bellow and the second air chamber comprises a second bellow.

28. The method of claim 25, wherein the patient simulator further comprises:
an air supply; and
at least one valve in communication with the air supply and the second air chamber, wherein the at least one valve is configured to connect the air supply to the second air chamber and connect the second air chamber to atmosphere; and
wherein the simulating the blood pressure of the patient simulator further comprises using the air supply and the at least one valve to simulate the blood pressure.

29. The method of claim 28, wherein the simulating the blood pressure of the patient simulator includes selectively inflating and deflating the second air chamber using the air supply and the at least one valve.

30. The method of claim 29, wherein the selectively inflating and deflating the second air chamber using the air supply and the at least one valve comprises moving the valve between a first position connecting the air supply to the second air chamber and a second position connecting the second air chamber to atmosphere.

31. The method of claim 29, wherein the selectively inflating and deflating the second air chamber using the air supply and the at least one valve comprises:
selectively opening and closing a first valve connecting the air supply to the second air chamber; and
selectively opening and closing a second valve connecting the second air chamber to atmosphere.

32. The method of claim 25, wherein the simulating the pulse of the patient simulator by selectively contacting the first air chamber with the mechanism for selectively contacting the first air chamber comprises:
controlling actuation of the at least one valve to cause the second air chamber to selectively contact the first air chamber to provide the simulated pulse.

33. The method of claim 32, wherein the controlling the actuation of the at least one valve causes the second air chamber to selectively contact the first air chamber with varying amounts of force to provide the simulated pulse.

34. The method of claim 33, wherein the controlling the actuation of the at least one valve is based on a simulated blood pressure of the patient simulator.

35. The method of claim 34, wherein the simulated blood pressure is set by a user.

36. The method of claim 34, wherein the simulated blood pressure is based on a simulation profile.

37. The method of claim 23, wherein the simulated body portion includes a simulated arm and the air pressure sensor is positioned within an upper portion of the simulated arm; and
further comprising:
positioning a cuff of the automated pressure monitoring apparatus around the simulated arm, wherein the cuff is in communication with the air line of the automated pressure monitoring apparatus.

38. The method of claim 23, wherein the connecting the air line of the automated pressure monitoring apparatus to the air pressure sensor of the patient simulator comprises connecting an adapter to the air line of the automated pressure monitoring apparatus such that the air pressure sensor can monitor an air pressure generated by the automated pressure monitoring apparatus.

39. The method of claim 38, wherein the connecting the air line of the automated pressure monitoring apparatus to the air pressure sensor of the patient simulator further comprises having tubing extend between the adapter and the air pressure sensor.

40. The method of claim 39, wherein the connecting the adapter to the air line of the automated pressure monitoring apparatus comprises:
coupling a first portion of the air line extending from a monitor of the automated pressure monitoring apparatus to the adapter; and
coupling a second portion of the air line extending from a cuff of the automated pressure monitoring apparatus to the adapter.
